(19) United States
(12) Patent Application Publication
(10) Pub. No.: US 2006/0095244 A1
(43) Pub. Date: May 4, 2006

(54) Model-based device configuration

(76) Inventor: Randall Edward Messick, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/975,010

(22) Filed: Oct. 28, 2004

(51) Int. Cl. G06F 13/10

(52) U.S. Cl. 703/21

(57) ABSTRACT

A method, of virtually configuring a subject device, may include: providing a model of a subject device that is to be configured; and configuring the model to obtain a revised model.

### BACKGROUND OF THE PRESENT INVENTION

A data storage system according to the Background Art typically includes a storage device that itself includes a plurality of hard disk drives. Efficient use of the hard disk space can be achieved by logically apportioning the hard disk space among multiple users/consumers-of-storage-capacity. Security/redundancy for the data as needed/desired can be achieved by using such techniques as striping the data across multiple disk drives, etc. The users/consumers of the data storage system are typically unaware of the physical locations and/or or redundancy provisions for their data. Such logical apportioning, data redundancy, etc. is under the control of an administrator of the storage system, who typically uses some type of configuration tool to achieve the logical apportioning, redundancy, etc.

An architecture of such a data storage system according to the Background Art has the administrator and the configuration tool connected to the storage device while the administrator configures or reconfigures the storage device. Fig. depicts such a storage system architecture.

FIG. 1 is a block diagram of a storage system architecture 102 according to the Background Art.

Architecture 102 includes: a storage device 102; a computing platform host 106; and (optionally) a computing platform host 120. Host 106 is typically local relative to storage device 104. In contrast, host 120 may be remote relative to storage device 104.

Components of a typical storage device 104 are shown in an exploded view, and include: physical ports, port 1 (190), port 2 (192), . . . port N (196); logical unit numbers (LUNs) LUN=1 (182), LUN=2 (184), . . . LUN=N (186); and multiple physical non-volatile memory devices 188 such as disk drives, tape drives and/or solid-state memory. Storage device 104 can also exhibit controllable-configuration functionality, monitoring functionality and/or mechanical functionality (such as tape changing), etc. Each LUN is a mapping of a virtual storage space to at least part of one or more of non-volatile memory devices 188.

Local host 106 includes: a configuration unit 108; a driver 110 for communicating with storage device 104, e.g., a Fibre Channel driver commonly used with a storage area network (SAN); a man-machine interface (MMI) 114; and a local application-program interface (API) 116. An administrator (person) 112 local relative to storage device 104 can directly configure storage device 104 via interaction with MMI 114, which connects to configuration unit 108 via local-API 116. Administrator 112, as well as configuration unit 108, are connected to storage device 104 for the total duration of the time that it takes for administrator 112 to make each change to the configuration of storage device 108.

Remote host 120 includes: an MMI 122; and a remote API 124. An administrator (person) 118 remote relative to storage device 104 can directly configure storage device 104 via interaction with MMI 122, which connects to configuration unit 108 via remote-API 116. As with local administrator 112, remote administrator 118 and configuration unit 108 are connected to storage device 104 for the total duration of the time that it takes for administrator 118 to make each change to the configuration of storage device 108.

### SUMMARY OF THE PRESENT INVENTION

At least one embodiment of the present invention provides a method of virtually configuring a subject device. Such a method may include: providing a model of a subject device that is to be configured; and configuring the model to obtain a revised model.

Other embodiments are contemplated.

Additional features and advantages of the invention will be more fully apparent from the following detailed description of example embodiments, the accompanying drawings and the associated claims.

### BRIEF DESCRIPTION OF THE DRAWINGS

The present invention will be described more fully with reference to the accompanying drawings, of which those not labeled “Background Art” depict example embodiments of the present invention. The accompanying drawings: should not be interpreted to limit the scope of the present invention; and not to be considered as drawn to scale unless explicitly noted.

FIG. 1 is a block diagram of a storage system architecture according to the Background Art.

FIG. 2 is a block diagram of a storage system architecture according to at least one embodiment of the present invention.

FIGS. 3A-3B are UML-type sequence diagrams of a model-based method of configuring a storage device, according to at least one embodiment of the present invention. In a sequence diagram, [symbol] indicates an action that expects a response message. A [symbol] indicates a response message. A [symbol] indicates an action for which the response is implied. And a [symbol] indicates an action for which no response is expected.

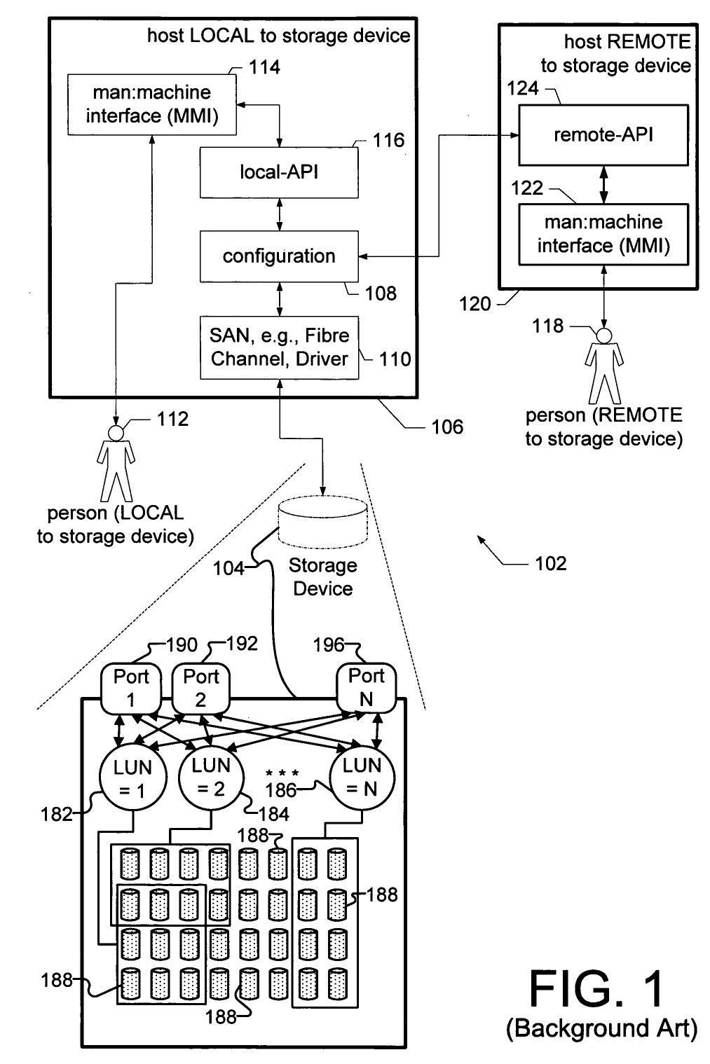

### DETAILED DESCRIPTION OF EXAMPLE EMBODIMENTS

In developing the present invention, the following problem with the Background Art was recognized and a path to a solution identified.

Storage system architecture 102 according to the Background Art requires that configuration unit 108 and administrator 112/118 be connected to storage device 104 for the total duration of the time that it takes for administrator 112/118 to make each configuration change. This presumes that a network connection between configuration unit 108 and storage device 104, and (in the case of remote administrator 118) a connection between configuration unit 108 and remote-API 124, are always (or, in other words, infinitely) available. But there are many circumstances in which such connections are not available, e.g., network failures, network blackouts (e.g., as experienced by U.S. naval vessels), etc. Where there is a window of time in which the necessary network connection exists, it may be of so short a duration as to preclude administrator 108/112 from making each change. Thus, in developing the present invention, it was recognized that the presumption of infinite network connectivity creates a problem when confronted with the realities of limited network availability.

A simplistic solution to the problem might be to collect the configuration changes that an administrator 112/118 desires to make into a batch file, and then submit the batch file to configuration unit 108. This presumes that administrator 112/118 can model the changes to be made in her own mind. It should be recognized that such changes often are not completely independent of each other. In other words, a second change often will build upon a first change. This can be described as a type of recursion. It would be advantageous to free administrator 112/118 from having to mentally model recursive changes to storage device 104 as a part of batching the configuration changes. At least one embodiment of the present invention provides a tool that batches configuration changes and frees the administrator from having to mentally model recursive changes.

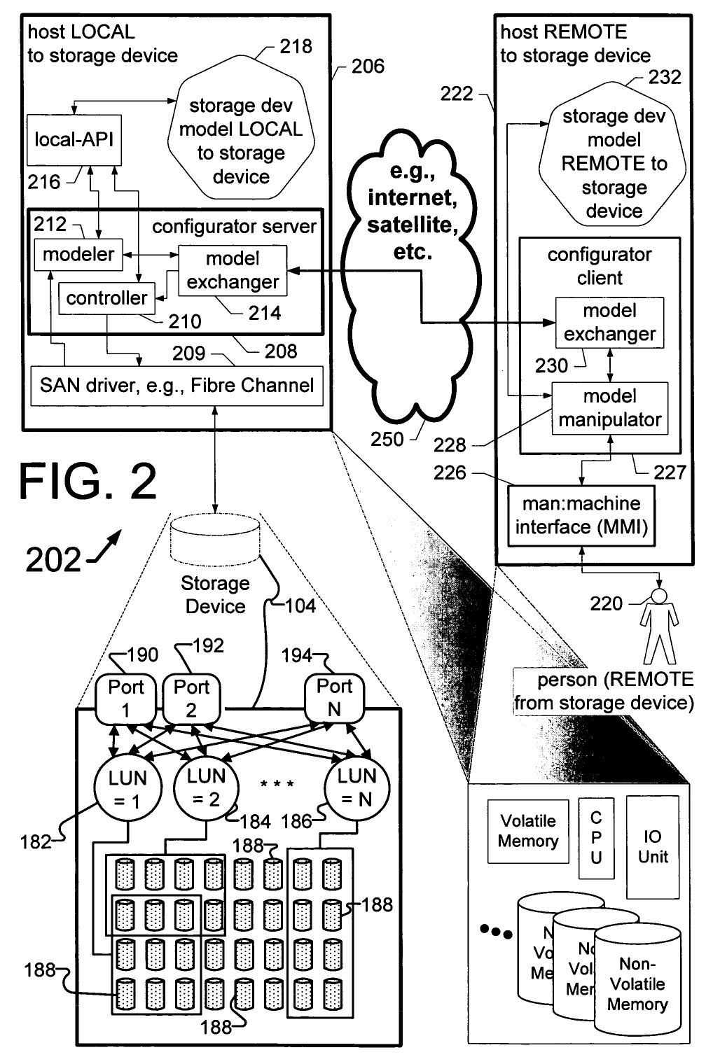

FIG. 2 is a block diagram of a storage system architecture 202 according to at least one embodiment of the present invention.

Storage system architecture 202 includes: storage device 104; a computing platform host 206; and a computing platform host 222. Host 206 is local relative to storage device 104. Host 120 can be, but is not necessarily, remote relative to storage device 104.

Components of a typical storage device 104 are, again, shown in an exploded view, as mentioned above. Each of hosts 206 and 222 can be a typical computer (also referred to as a PC). Typical hardware components for such a computer are depicted in an exploded view, and can include a CPU/controller, an I/O unit, volatile memory such as RAM and non-volatile memory media such disk drives and/or tape drives, ROM, flash memory, etc.

Host 206 can host: a configurator server 208; and a model 218 of storage device 104. Model 218 can, e.g., be represented in a database. Configurator server 208 can, e.g., be a service running on host 206.

Host 206 further can include: a driver 209 by which configurator server 208 can communicate with storage device 104, e.g., a Fibre Channel driver commonly used with a storage area network (SAN); and a local application-program interface (again, API) 216 by which configurator server 208 can communicate with model 218.

Host 222 can host: a configurator client 227; and a model 232 of storage device 104. Model 232 can, e.g., be represented in a database. Configurator client 227 can, e.g., be a service running on host 206.

Host 222 further can include a man-machine interface (again, MMI) 226. An administrator (person) 220 local relative to configurator client 227 can indirectly (or, in other words, virtually) configure storage device 104 via interaction with MMI 226, which connects substantially directly to configurator client 227, and indirectly to configurator server 208 via configurator client 227. In other words, configurator client 227 can be described as a virtual configuration unit.

Any configuration action upon storage device 104 that might be available to user 112/118 of Background architecture 102 can be carried out via architecture 202. Examples of how administrator 220 might configure storage device 104 include creating/revising a logical volume, setting a fault tolerance type, setting user access security parameters, etc.

There exists a sub-architecture in architecture 202. As their name implies, configurator client 227 and configurator server 208 represent a client-server architecture that can be viewed as a subset of architecture 202. Configurator client 227 can connect to configurator server 208 via a variety of network-type connections 250, e.g., over a path that includes the Internet. Such a connection, e.g., can be a TCP/IP connection.

Configurator server 208 includes: a controller 210; a modeler 212; and a model exchanger 214. Controller 210, modeler 212 and server-side exchanger 214 can also be services running on host 206.

Configurator client 227 includes: a model manipulator 228; and a model exchanger 230. Model-manipulator 228 and client-side exchanger 230 can also be services running on host 222.

The operation of architecture 202 will now be discussed.

Assume that administrator 220 desires to change the configuration of storage device 104. Accordingly, administrator 220 can interact with configurator client 227 to make one or more changes. More particularly, administrator 220 can interact with model-manipulator 228 via MMI 226 to request the change, e.g., by initially requesting a current copy of local model 218. Model-manipulator 228 can request a current copy of local model 218, and that request can be communicated to modeler 212 of configurator server 208 via exchangers 230 and 214. Modeler 212 can either instantiate or update local model 218 according to the current configuration of storage device 104. Then modeler 212 can send a copy of local model 218 to client configurator 227 via exchangers 230 and 214.

Client-side exchanger 230 can then overwrite/create the contents of remote model 232 according to the received copy of model 218. Then model-manipulator can facilitate instruction by administrator 220 of how the configuration of storage device 104 is to be changed. Such facilitation can take the form of model-manipulator interacting with administrator 220 to effect changes to the configuration of remote model 232. When finished making changes, administrator 220 can command that the changes represented by then-revised remote model 232 be committed to storage device 104. Then model-manipulator 227 can send a copy of revised remote model 232 to configurator server 208 via exchangers 230 and 214.

Server-side exchanger 214 can overwrite local model 218 according to the copy of revised remote model 232. Controller 210 can then update the actual configuration of storage device 104 according to the virtual configuration dictated by updated local model 218.

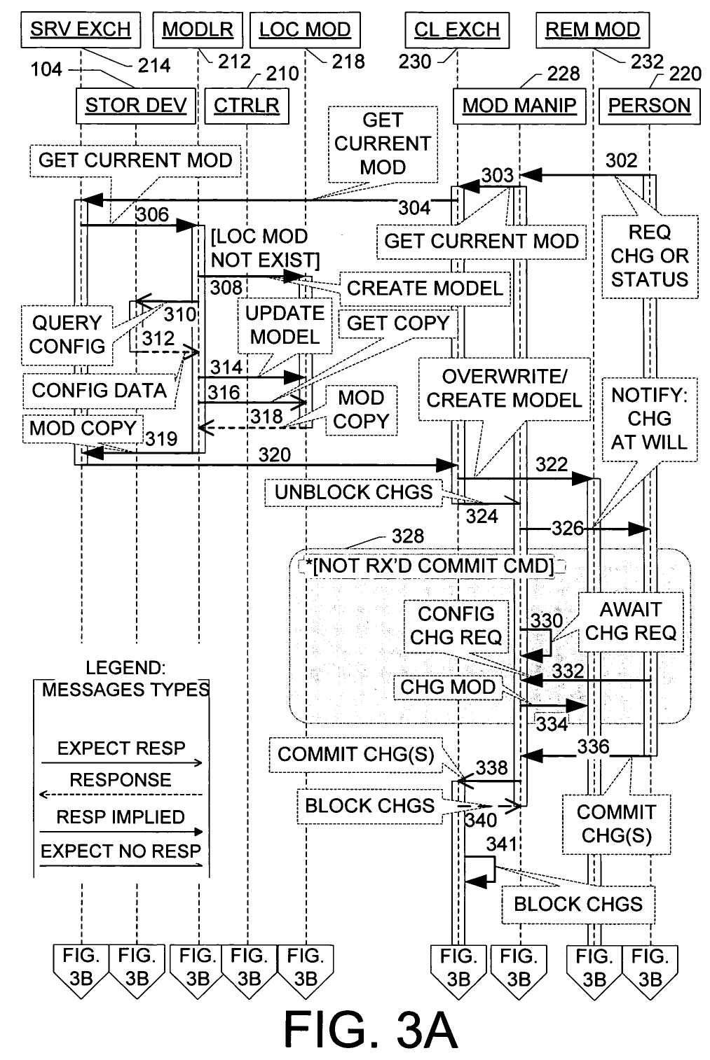

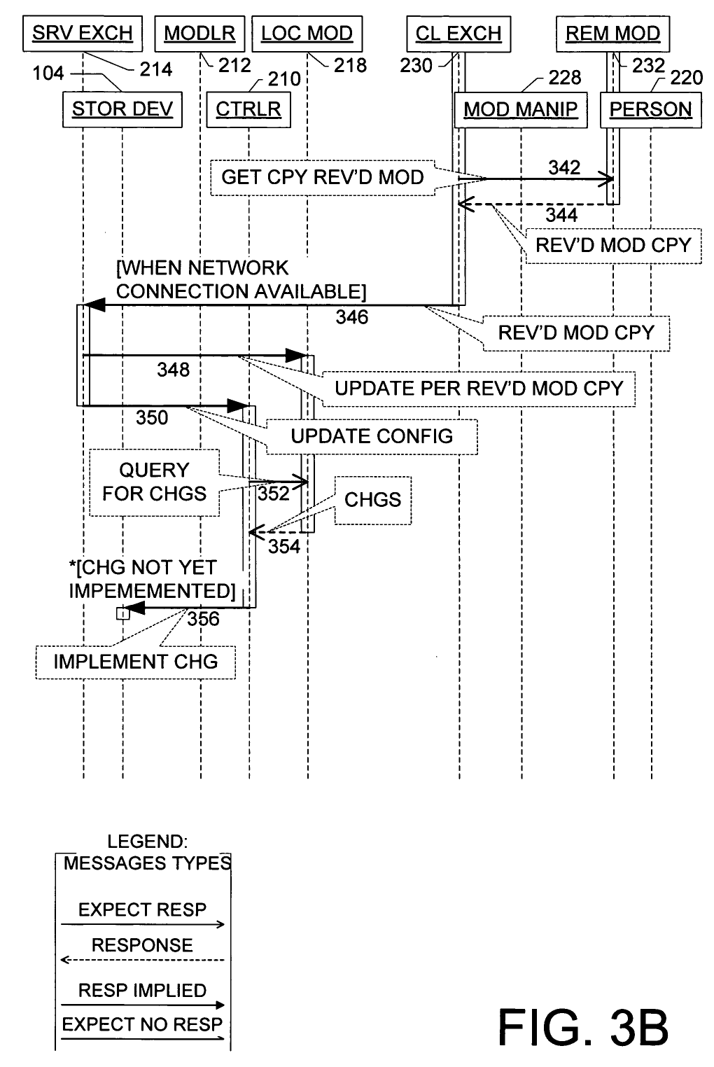

A more detailed discussion of the operation is provided as follows via reference to FIGS. 3A-3B.

FIGS. 3A-3B are UML-type sequence diagrams of a model-based method of configuring a storage device, according to at least one embodiment of the present invention.

In FIG. 3A, configuring of storage device 104 can begin by a message 302 from administrator (person) 220 to model-manipulator 228 requesting to make changes to storage device 104. For example, if such a request is the first to be follow a command to commit changes to storage device 104, then model-manipulator 228 can response by first arranging to obtain a current configuration of storage device 104. Alternatively, message 302 can merely be a request for a status of the configuration of storage device 104. Model-manipulator 228 can send a message 303 to client-side exchanger 230 requesting a current copy of local model 218. At message 304, client-side exchanger 230 can forward the request to server-side exchanger 214, which can forward the request to modeler 212 at message 306.

At message 308, modeler 212 can create (or, in other words, can instantiate) local model 218 if it does not already exist. The conditional nature of message 308 is indicated in UML-type notation by providing message 308 with the label “*[LOC MOD NOT EXIST].” The square brackets ([ ]) denote a condition which must be true for the message to occur. Here, the condition for message 304 is that local model 218 must not exist if message 308 is to occur. If local model 218 already exists, then message 218 will not occur.

After conditional message 308, modeler 212 can query (via driver 209) storage device 104 for its current configuration at message 310. At message 312, storage device 104 can reply to modeler 212 with data describing its current configuration. At message 314, modeler 212 can update local model 218 with the current configuration data for storage device 104. At message 316, modeler 212 can request a copy of local model 218 from local model 218. At message 318, local model 218 can provide a copy of itself to modeler 212, which can pass the copy to server-side exchanger 214 at message 319.

At message 320, server-side exchanger 214 can forward the copy of local model 218 to client-side exchanger 230. At message 322, client-side exchanger 230 can overwrite or can create/instantiate (if not yet in existence) remote model 232 with the copy of local model 218. At message 324, client-side exchanger 230 can notify model-manipulator 228 to unblock changes to remote model 232. As will be discussed below, model-manipulator 228 can block changes requested by administrator 220 after revised remote model 232 is sent to configurator server 208 and until a current copy of local model 218 is again reflected by remote model 232.

After message 324, model-manipulator 228 can notify administrator 220 (via MMI 226) that she can make changes at will to remote model 232. Then loop 328 is entered in which such changes are made. Again, making changes to remote model 232 represents instructions to change storage device 104. A condition for exiting loop 328 is given by the label “*[NOT RX'D CMD COMMIT]”. In UML notation, the asterisk (*) denotes iteration, and iteration of loop 328 can continue while the statement within the square brackets is true. Here, the statement for loop 328 indicates that looping can continue so long as so long as model-manipulator 228 has not received a command from administrator 220 (via MMI 226) to commit the changes to storage device 104.

Inside loop 328, at self-message model-manipulator 228 can await receipt (via MMI 226) of a configuration change to remote model 232 from administrator 220. At message 332, administrator 220 can submit (via MMI 226) a change for the configuration of remote model 232 to model-manipulator 228. At message 334, model-manipulator 228 accordingly can change remote model 232. If, subsequently, a commit-changes command is not received by model-manipulator 228 from administrator 220 (via MMI 226), then flow can iterate inside 328.

At some subsequent time, it is assumed that administrator 220 submits (via MMI 226) a commit-changes command to model-manipulator 228, as indicated by message 336. At message 338, model-manipulator 228 can forward the commit-change command to client-side exchanger 230. At message 340, client-exchanger can notify model-manipulator to block further change-requests from administrator 220. At self-message 341, model-manipulator accordingly can block change-requests from administrator 220. If administrator 220 wants to make additional changes, then model-manipulator 228 can block receipt of the change-requests until a current configuration of local model 218 is stored in remote model 232. See, e.g., messages 302 et seq.

Self-message 341 is the last message in FIG. 3A. Flow continues from there into FIG. 3B.

In FIG. 3B, at message 342, client-side exchanger 230 can request a copy of revised remote model 232. At message 344, remote model 232 can provide a copy of itself to client-side exchanger 230, which can pass the copy to server-side exchanger 214 at message 346.

It is to be noted that message 346 is a conditional message, having the label “[WHEN NETWORK CONNECTION AVAILABLE]”. Again, a network connection between configurator client 227 and configurator server 208 will not always be available. Unavailability can be caused by network failures, network blackouts, circumstances that prevent the setup/use of communication equipment, etc. Examples of situations in which such causes can arise include: a naval vessel such as a submarine that has communication blackouts for security purposes and/or because of location (such as under a polar ice-cap); a remote military battlefield environment in which hostilities preclude setting up communication equipment and/or there is a communication blackout for security purposes; a remote scientific exploration; a developing country in which, e.g., the electrical power supply is inconsistent; etc.

At message 348 (that follows message 346), server-side exchanger 214 can update the data in local model 218 according to the copy of revised remote model 232. For example, as part of the update, local model 218 can log which parameters changed. It is noted that the connection between exchangers 214 and 230 corresponding to message 346 will typically have been broken by the time that message 348 is sent. At message 350, server-side exchanger 214 can notify controller 210 to update the configuration of storage device 104. At message 352, controller 210 can query local model 218 for parameters that changed as of the most recent update.

At message 352, local model 218 can supply controller 210 with data that represent the configuration changes which need to be made to storage device 104. At message 356, controller 210 can update (via driver 209) the configuration of storage device 104. It is to be noted that message 356 is a conditional iterative message, having the label “*[CHG NOT YET IMPLEMENTED]”. Message 356 can repeat so long as there remains a configuration change that controller 210 has not yet implemented (via driver 209) into storage device 104.

At least one embodiment of the present invention permits an administrator to administer one or more storage devices 104 remotely. For example, consider a bank which has multiple branches at different locations, where each branch has its own storage device 104. Administrator 220 for the bank can configure each branch's storage device 104 from the same remote location using architecture 202.

Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

What is claimed:

1. A device-configuration tool comprising:
a memory containing a model of a subject device that is to be configured; and
a virtual configuration unit operable to configure the model.

2. The tool of claim 1, wherein the subject device is a storage device.

3. The tool of claim 1, wherein the virtual configuration tool is operable to indirectly configure the subject device via configuration of the model.

4. The tool of claim 1, further comprising:
a man-machine interface operable to facilitate communication of configuration parameter settings from an administrator to the virtual configuration unit;
the virtual configuration unit being operable to transform the model from an initial state to a revised state based upon the configuration parameter settings.

5. The tool of claim 4, wherein:
the virtual configuration unit represents a client in a context of a client-server architecture.

6. The tool of claim 5, further comprising:
a server, with respect to the client in the context of the client-server architecture, operable to
receive a copy of the revised model from the virtual configuration unit, and
configure the subject device according to the revised model.

7. The tool of claim 6, wherein:
the virtual configuration unit is remote relative to the subject device; and
the server is local relative to the subject device.

8. The tool of claim 1, wherein:
the virtual configuration unit is offline with respect to a connection status with the server while receiving configuration parameter settings from the man-machine interface and while transforming the model from the initial state to the revised state; and
the virtual configuration unit is online with respect to a connection status with the server while virtual configuration unit provides a revised model to the server.

9. The tool of claim 1, wherein the model is represented in a database.

10. A device-configuration tool comprising:
a memory containing a model of a subject device that is to be configured; and
a configurator unit operable to configure the subject device according to the model.

11. The tool of claim 10, wherein the subject device is a storage device.

12. The tool of claim 10, wherein an administrator indirectly configures the subject device via the model while the configurator unit directly configures the subject device via configuration according to the model.

13. The tool of claim 10, wherein the configurator unit includes:
a modeler unit to do at least one of
instantiate the model to represent the subject device, and
update the model with respect to the subject device.

14. The tool of claim 13, wherein:
the configurator unit further is local relative to the subject device; and
the configurator unit further includes
an exchanger unit to provide a copy of the model to a virtual configuration unit that is remote relative to the subject device.

15. The tool of claim 14, wherein:
the exchanger unit is further operable to receive a revised model from the virtual configuration unit.

16. The tool of claim 14, wherein:
the configurator unit is offline with respect to a connection status with the virtual configuration unit while the virtual configuration unit receives configuration parameter settings from an administrator of the subject device and while the virtual configuration unit transforms the model from an initial state to a revised state; and
the configurator unit is online with respect to a connection status with the virtual configuration unit while the configurator unit receives a revised model from the virtual configuration unit.

17. The tool of claim 10, wherein the model is represented in a database.

18. The tool of claim 10, wherein the configurator unit includes:
a controller operable to configure the subject device; and
an exchanger unit to provide one of the model or a version thereof to the controller.

19. The tool of claim 18, wherein:
the configurator unit is local relative to the subject device;
the configurator unit further includes
an exchanger unit to receive a revised version of the model from a virtual configuration unit that is remote relative to the subject device and provide the revised model to the controller; and
the controller is operable to configure the subject device according to the revised model.

20. The tool of claim 15, wherein the configurator unit is local relative to the subject device.

21. A method of virtually configuring a subject device, the method comprising:
providing a model of a subject device that is to be configured; and
configuring the model to obtain a revised model.

22. The method of claim 21, wherein the subject device is a storage device.

23. The method of claim 21, further comprising:
configuring the subject device according to the model.

24. The method of claim 23, wherein:
the configuring of the subject device is performed locally relative to the subject device; and
the configuring of the model is performed remotely relative to the subject device.

25. The method of claim 23, wherein:
the providing of the model includes receiving the model; and
at least one of the following is true, namely
the configuring of the model is performed offline with respect to a connection by which the revised model is received;
the configuring of the subject device is performed offline with respect to a connection by which the revised model is received.

26. The method of claim 21, further comprising representing the model in a database.

27. A device-configuration method comprising:
receiving a revised model of a subject device that is to be configured; and
configuring the subject device according to the revised model.

28. The method of claim 27, further comprising:
providing an unrevised model of a current configuration of the subject device for revision thereto;
wherein the revised model represents a revised version of the model.

29. The method of claim 27, wherein the subject device is a storage device.

30. The method of claim 27, wherein:
the revised model represents indirect configuration of the subject device in contrast to the configuring of the subject device which represents direct configuration.

31. The method of claim 27, wherein:
the configuring of the subject device is performed locally relative to the subject device; and
configuration of the revised model occurs at a location remote relative to the subject device.

32. The method of claim 27, wherein at least one of the following is true:
configuration of the revised model occurs offline with respect to a connection by which the revised model is received;
the configuring of the subject device is performed offline with respect to a connection by which the revised model is received.

33. The method of claim 27, further comprising representing the model in a database.

34. A machine-readable medium including instructions execution of which by a machine virtually configures a subject device, the machine-readable instructions comprising:
code segments that perform the method of claim 21.

35. A machine-readable medium including instructions execution of which by a machine virtually configures a subject device, the machine-readable instructions comprising:
code segments that perform the method of claim 22.

36. A machine-readable medium including instructions execution of which by a machine virtually configures a subject device, the machine-readable instructions comprising:
code segments that perform the method of claim 23.

37. A machine-readable medium including instructions execution of which by a machine virtually configures a subject device, the machine-readable instructions comprising:
code segments that perform the method of claim 24.

38. A machine-readable medium including instructions execution of which by a machine virtually configures a subject device, the machine-readable instructions comprising:
code segments that perform the method of claim 25.

39. A machine-readable medium including instructions execution of which by a machine virtually configures a subject device, the machine-readable instructions comprising:
code segments that perform the method of claim 26.

40. A machine-readable medium including instructions execution of which by a machine virtually configures a subject device, the machine-readable instructions comprising:
code segments that perform the method of claim 27.

41. A machine-readable medium including instructions execution of which by a machine virtually configures a subject device, the machine-readable instructions comprising:
code segments that perform the method of claim 28.

42. A machine-readable medium including instructions execution of which by a machine virtually configures a subject device, the machine-readable instructions comprising:
code segments that perform the method of claim 29.

43. A machine-readable medium including instructions execution of which by a machine virtually configures a subject device, the machine-readable instructions comprising:
code segments that perform the method of claim 30.

44. A machine-readable medium including instructions execution of which by a machine virtually configures a subject device, the machine-readable instructions comprising:
code segments that perform the method of claim 31.

45. A machine-readable medium including instructions execution of which by a machine virtually configures a subject device, the machine-readable instructions comprising:
code segments that perform the method of claim 32.

46. A machine-readable medium including instructions execution of which by a machine virtually configures a subject device, the machine-readable instructions comprising:
code segments that perform the method of claim 33.

47. An apparatus for virtually configuring a storage device, the apparatus comprising:
memory means for storing a model of a storage device that is to be configured; and
virtual configuration means for configure the model.

48. The apparatus of claim 47, wherein the virtual configuration means is remote relative to the subject device.

49. An apparatus for configuring a storage device, the apparatus comprising:
input/output (I/O) means for receiving a revised model of a storage device that is to be configured; and
controller means for configuring the subject device according to the revised model.

50. The apparatus of claim 49, wherein:
the revised model represents indirect configuration of the storage device in contrast to the configuring of the storage device which represents direct configuration.
